(19) United States
(12) Patent Application Publication
(10) Pub. No.: US 2010/0214376 A1
(43) Pub. Date: Aug. 26, 2010

(54) INK TUBE FOR INKJET PRINTER

(76) Inventors: Hiroaki Nakano, Hyogo (JP); Hideyuki Okuyama, Hyogo (JP)

Correspondence Address: BIRCH STEWART KOLASCH & BIRCH, PO BOX 747, FALLS CHURCH, VA, 22040-0747, US

(21) Appl. No.: 12/682,729

(22) PCT Filed: Oct. 9, 2008
(86) PCT No.: PCT/JP2008/068376

§ 371 Date: Apr. 12, 2010

(30) Foreign Application Priority Data
Oct. 15, 2007 (JP) 2007-267651

(51) Int. Cl. B41J 2/175

(52) U.S. Cl. 347/85

(57) ABSTRACT

Disclosed is an ink tube for ink-jet printers, which has excellent flexibility and workability, while being small in compression set as well as in water vapor permeability and air permeability. Specifically, an ink tube for ink-jet printers is made from a thermoplastic elastomer composition which contains a rubber component containing a butyl rubber at a ratio of not less than 30% by mass but not more than 80% by mass, not less than 5 parts by mass but not more than 50% parts by mass of an olefin thermoplastic resin per 100 parts by mass of the rubber component, and not less than 10 parts by mass but not more than 100 parts by mass of a hydrogenated styrene thermoplastic elastomer per 100 parts by mass of the rubber component. In this thermoplastic elastomer composition, the rubber component is finely dispersed by dynamic crosslinking.

### TECHNICAL FIELD

The present invention relates to an ink tube for an ink-jet printer and in detail to a tube for an ink-jet printer formed by molding a thermoplastic elastomer composition in which dynamically crosslinked rubber is dispersed. More particularly the ink tube of the present invention has excellent flexibility and processability, a low permeability of vapor and air, and a small compression set.

### BACKGROUND ART

In the ink-jet printer, the ink tube is coupled to an ink head to transport ink. The ink tube is used to discharge waste ink to the outside of the ink head when the ink head is cleaned and supply the ink to the ink head from an ink tank.

The ink tube is demanded to be low in its vapor permeability and air permeability to prevent the ink inside the ink tube from drying and deteriorating. Because it is necessary for the ink tube to have a kink resistance (resistance of ink tube to bending), the ink tube is demanded to have a proper degree of flexibility.

Regarding the ink tube of this kind, in recent years, an ink tube composed of a thermoplastic elastomer superior to rubber in its processability and recyclability is proposed.

As disclosed in Japanese Patent Application Laid-Open No. 2004-142364 (patent document 1), the present applicant proposed an ink tube, for an ink-jet printer, formed by molding the thermoplastic elastomer composition which has a Shore A hardness not more than 70 contains the rubber component, containing not less than 30 wt % of the butyl rubber, which is finely dispersed in the olefin thermoplastic resin by dynamic crosslinking. The ink tube has an improved flexibility and a low vapor permeability and a low air permeability.

Patent document 1: Japanese Patent Application Laid-Open No. 2004-142364

### DISCLOSURE OF THE INVENTION

### Problem to be Solved by the Invention

But with the miniaturization of the ink-jet printer in recent years, the ink tube is demanded to be compact. With the miniaturization of an ink-jet printer apparatus and the ink tube, there is a case in which the ink tube connected to a moving part such as an ink tank is disposed by folding it. Therefore the ink tube is demanded to have improved flexibility and an improved property of returning to its original state when it is bent.

Because the inside of the ink-jet printer is filled with heat to generate a hot environment, the ink tube is demanded to have heat resistance to a higher extent.

The present invention has been made in view of the above-described problem. It is an object of the present invention to provide an ink tube, for an ink-jet printer, which has excellent flexibility and processability, a low permeability of vapor and air, and a small compression set.

### Means for Solving the Problem

To solve the above-described problem, the present invention provides an ink tube, for an ink-jet printer, formed by molding a thermoplastic elastomer composition including:

a rubber component containing butyl rubber at not less than 30 mass % nor more than 80 mass %;

not less than 5 parts by mass nor more than 50 parts by mass of an olefin thermoplastic resin for 100 parts by mass of the rubber component; and

not less than 10 parts by mass nor more than 100 parts by mass of a hydrogenated styrene thermoplastic elastomer for 100 parts by mass of the rubber component,

wherein the rubber component is finely dispersed by dynamic crosslinking.

The present inventors have studied earnestly and found that the above-described problem can be solved by forming the ink tube for the ink-jet printer (hereinafter often referred to as merely “ink tube”) from the thermoplastic elastomer composition in which as the rubber component, the butyl rubber and other rubber components are combined with each other, the content ratio of the butyl rubber is set to 30 to 80 mass % for the entire rubber component, and further as the matrix in which the dynamically crosslinked rubber component is dispersed, the mixture of the olefin thermoplastic resin and the hydrogenated styrene thermoplastic elastomer is used at a specific mixing ratio. That is, the ink tube formed by molding the thermoplastic elastomer composition is excellent in its processability, flexible and low in its hardness, small in its compression set, and in addition very low in the permeability of vapor and air.

By using the hydrogenated styrene thermoplastic elastomer at the above-described mixing ratio, it is possible to make the hardness of the thermoplastic elastomer composition low and the compression set thereof small without impairing the processability thereof and with good properties thereof such as vapor permeability resistance and air permeability resistance kept unchanged. Because the ink tube formed by molding the thermoplastic elastomer composition having a low hardness and a small compression set, it is possible to adjust the hardness and compression set of the ink tube of the present invention for the ink-jet printer to a preferable hardness and a preferable compression set. The processability of the thermoplastic elastomer composition forming the ink tube can be improved by increasing the amount of the olefin thermoplastic resin or/and that of the hydrogenated styrene thermoplastic elastomer. But when the amount of only the olefin resin is increased, the compression set significantly deteriorates.

The deterioration of the compression set is significant at a high temperature when the amount of only the olefin resin is increased. But by using the olefin thermoplastic resin and the hydrogenated styrene thermoplastic elastomer at the above-described mixing ratio respectively, it is possible to prevent the deterioration of the compression set.

The reason the hydrogenated styrene thermoplastic elastomer is used for the thermoplastic elastomer composition is because the hydrogenated styrene thermoplastic elastomer has a favorable affinity for a plasticizer such as oil. In a case where the thermoplastic elastomer composition is demanded to be flexible to a higher extent, the hardness thereof is often adjusted by adding the plasticizer such as oil to the thermoplastic elastomer composition. Because the hydrogenated styrene thermoplastic elastomer has a favorable affinity for the plasticizer such as the oil, when the plasticizer is added thereto, it is possible to process the thermoplastic elastomer composition easily and prevent the plasticizer from bleeding from a molding.

Because the double bonds of the hydrogenated styrene thermoplastic elastomer are saturated by hydrogenation, the hydrogenated styrene thermoplastic elastomer does not inhibit the dynamic crosslinking of the rubber component. This is one of the reasons the hydrogenated styrene thermoplastic elastomer is used.

Each of the components of the thermoplastic elastomer composition forming the ink tube of the present invention for the ink-jet printer is described in detail below.

As the butyl rubber, known compounds may be used. Isobutylene-isoprene copolymer rubber, halogenated isobutylene-isoprene copolymer rubber, and denatured substances thereof are exemplified. As the denatured substance, a bromide of a copolymer of isobutylene and p-methylstyrene is exemplified.

The degree of unsaturation (amount of isoprene in the case of isobutylene-isoprene copolymer rubber) of the butyl rubber is normally 0.6 to 2.5 mol %.

As preferable halogen of the halogenated isobutylene-isoprene copolymer rubber, chlorine and bromine are exemplified. The content of the halogen is normally 1.1 to 2.4 mass %.

As the butyl rubber, one kind may be used singly or not less than two kinds may be used in combination. It is favorable for the rubber component to contain the isobutylene-isoprene copolymer rubber and more favorable to contain only the isobutylene-isoprene copolymer rubber.

The butyl rubber may be used in combination with other rubber components. As described above, the content ratio of the butyl rubber to the entire rubber component is set to 30 to 80 mass %. Thereby the vapor permeability of the thermoplastic elastomer composition and the air permeability thereof can be set low, and a high processability thereof can be securely obtained.

That is, the reason the above-described mixing ratio is set is because when the butyl rubber is contained in the rubber component at less than 30 mass %, the vapor permeability resistance of the butyl rubber and the air permeability resistance thereof cannot be displayed. On the other hand, when the butyl rubber is contained in the entire rubber component at more than 80 mass % of the entire rubber component, the high processability cannot be displayed. The above-described mixing ratio is set for the reason described below. Because the butyl rubber has a high Mooney viscosity, difficulties arise in dynamically crosslinking the rubber component. Further because the butyl rubber has a high adhesiveness, the obtained thermoplastic elastomer composition becomes adhesive. Thereby it is not easy to process the thermoplastic elastomer composition.

The “other rubber components” to be combined with the butyl rubber is not limited to specific ones. Nitrile rubber such as isoprene rubber, butadiene rubber, styrene-butadiene rubber, natural rubber, chloroprene rubber, acrylonitrile-butadiene rubber, hydrogenated nitrile rubber, norbornene rubber, ethylene propylene rubber, ethylene-propylene-diene rubber, acrylic rubber, ethylene acrylate rubber, fluorine rubber, chlorosulfonated polyethylene rubber, epichlorohydrin rubber, silicone rubber, urethane rubber, polysulfide rubber, phosphazene rubber, and 1,2-polybutadiene rubber are listed.

As the “other rubber components”, above all, rubbers compatible with the butyl rubber are preferable. The natural rubber, the isoprene rubber, the butadiene rubber, the styrene-butadiene rubber, the chloroprene rubber, the 1,2-polybutadiene rubber, the acrylonitrile-butadiene rubber, and the ethylene-propylene-diene rubber are preferable.

As the “other rubber components”, one kind of the above-described other rubbers may be used singly or not less than two kinds thereof may be used in combination.

As the “other rubber components”, rubber components having a high processability are preferable. Ethylene-propylene-diene rubber (hereinafter referred to as EPDM rubber) can be especially suitably used because it has a favorable processability and is excellent in the compatibility with the butyl rubber.

The EPDM rubber includes an oil-unextended type consisting of a rubber component and an oil-extended type containing the rubber component and extended oil. Both types can be used in the present invention. As examples of diene monomers of the EPDM rubber, dicyclopentadiene, methylene norbornene, ethylidene norbornene, 1,4-hexadiene, and cyclooctadiene are listed.

As the olefin thermoplastic resin to be used in the present invention, polyethylene, polypropylene, ethylene ethyl acrylate resin, ethylene vinyl acetate resin, ethylene-methacrylate resin, ionomer resin, and chlorinated polyethylene are listed. Of these olefin thermoplastic resins, it is favorable to use the polypropylene or the polyethylene. It is more favorable to use the polypropylene. This is because the polypropylene is more flowable and more compatible with the butyl rubber than the polyethylene.

As described above, the content of the olefin thermoplastic resin is set to not less than 15 parts by mass nor more than 50 parts by mass for 100 parts by mass of the rubber component to maintain excellent flexibility of the thermoplastic elastomer composition and securely obtain a high processability thereof. The reason the above-described mixing ratio is set is because when the content of the olefin thermoplastic resin is more than 50 parts by mass for 100 parts by mass of the rubber component, the mixing ratio of the rubber component becomes relatively low and hence the excellent flexibility derived from the rubber elasticity cannot be displayed. On the other hand, when the content of the olefin thermoplastic resin is less than 15 parts by mass for 100 parts by mass of the rubber component, a preferable flowability of the thermoplastic elastomer composition cannot be securely obtained, and difficulties arise in dynamically crosslinking the rubber component or problems occur in the processability of the thermoplastic elastomer composition.

The content of the olefin thermoplastic resin in the entire composition is set to favorably not more than 15 mass % and more favorably 10 to 15 mass %.

This is because when the content of the olefin thermoplastic resin in the entire composition exceeds 15 mass %, the thermoplastic elastomer composition has a high hardness. Thus the thermoplastic elastomer composition lacks flexibility, is difficult to display its rubber elasticity, and has an unfavorable kink resistance, which is unpreferable. On the other hand, when the content of the olefin thermoplastic resin is small, difficulties arise in dynamically crosslinking the rubber component and thus there is a case in which the processability of the thermoplastic elastomer composition becomes unfavorable. Therefore it is preferable that the content of the olefin thermoplastic resin in the entire composition is set to not less than 10 mass %.

As the hydrogenated styrene thermoplastic elastomer to be used in the present invention, it is possible to exemplify a hydrogenated conjugated diene polymer unit of a polymer block (A) containing a styrene monomer as its main component and a block (B) containing a conjugated diene compound as its main component. As the styrene monomer, it is possible to list styrene, α-methylstyrene, vinyl toluene, and t-butylstyrene. Only one kind of these monomers may be used or not less than two kinds thereof may be used in combination. The styrene is preferable as the styrene monomer. As the conjugated diene compound, it is possible to list butadiene, isoprene, chloroprene, and 2,3-dimethylbutadiene. Only one kind of these conjugated diene compounds may be used or not less than two kinds thereof may be used in combination.

As the hydrogenated styrene thermoplastic elastomers, a styrene-ethylene-styrene copolymer (SES), a styrene-ethylene/propylene-styrene copolymer (SEPS), a styrene-ethylene-ethylene/propylene-styrene copolymer (SEEPS), and a styrene-ethylene/butylene-styrene copolymer (SEBS) are listed.

It is especially favorable to use the styrene-ethylene-ethylene/propylene-styrene copolymer (SEEPS).

As described above, the content ratio of the hydrogenated styrene thermoplastic elastomer is set to not less than 10 parts by mass nor more than 100 parts by mass for 100 parts by mass of the rubber component. Thereby a good processability of the thermoplastic elastomer composition and a small compression set thereof can be displayed.

The reason the above-described mixing ratio is set is because when the content ratio of the hydrogenated styrene thermoplastic elastomer is more than 100 parts by mass for 100 parts by mass of the rubber component, the small compression set of the rubber component dynamically crosslinked cannot be displayed. On the other hand, when the mixing ratio of the hydrogenated styrene thermoplastic elastomer is less than 10 parts by mass for 100 parts by mass of the rubber component, the thermoplastic elastomer composition has a deteriorated processability and shows a high hardness, which is unpreferable in using the thermoplastic elastomer composition for the ink tube, for the ink-jet printer, which is demanded to be flexible.

A proper mixing ratio between the hydrogenated styrene thermoplastic elastomer and the olefin thermoplastic resin can be determined according to the kind of an elastomer to be used and that of a resin to be used. It is preferable to set the mixing amount of the hydrogenated styrene thermoplastic elastomer to not less than 30 parts by mass nor more than 300 for 100 parts by mass of the olefin thermoplastic resin. When the mixing amount of the hydrogenated styrene thermoplastic elastomer is less than 30 parts by mass, the hardness of the molding composed of the thermoplastic elastomer composition of the present invention is liable to become high. On the other hand, when the mixing amount of the hydrogenated styrene thermoplastic elastomer is more than 300 parts by mass, the ratio of the olefin thermoplastic resin becomes relatively small. Thus it is impossible to obtain the effect to be obtained by mixing the thermoplastic resin with the thermoplastic elastomer. For example, the processability of the thermoplastic elastomer composition and the like cannot be improved.

In the thermoplastic elastomer composition forming the ink tube of the present invention for the ink-jet printer, the rubber component containing the butyl rubber is dynamically crosslinked and dispersed in the mixture of the olefin thermoplastic resin and the hydrogenated styrene thermoplastic elastomer. The rubber component is dynamically crosslinked, with a shearing force being applied to the thermoplastic elastomer composition. For example, the rubber component can be dynamically crosslinked by using a twin screw extruder.

By crosslinking the rubber component with the shearing force being applied to the thermoplastic elastomer composition, it is possible to set the diameters of rubber particles in the thermoplastic elastomer composition to several micrometers to several tens of micrometers and finely disperse the rubber component in the mixture of the olefin thermoplastic resin and the hydrogenated styrene thermoplastic elastomer.

A crosslinking agent for dynamically crosslinking the rubber component is not limited to a specific one, but known crosslinking agents can be used, provided that they are capable of crosslinking the rubber component contained in the thermoplastic elastomer composition. Sulfur, a resin crosslinking agent, metal oxides, and organic peroxides are exemplified. Of these crosslinking agents, the resin crosslinking agent is preferable because owing to its use, there little occurs the problem of blooming which often occurs in materials crosslinked with sulfur and a vulcanization accelerator.

The resin crosslinking agent is a synthetic resin which allows the rubber component to make a crosslinking reaction by heating. In the present invention, the resin crosslinking agent is not limited to a specific one, but known resin crosslinking agents can be used.

As the resin crosslinking agents, phenolic resin, melamine•formaldehyde resin, triazine•formaldehyde condensate, hexamethoxymethyl•melamine resin are listed. It is preferable to use the phenolic resin because when the thermoplastic elastomer composition containing the phenolic resin is used as a member constructing a paper supply mechanism, paper supply performance can be enhanced.

As examples of the phenolic resin, phenolic resins synthesized by reaction of phenols such as phenol, alkylphenol, cresol, xylenol or resorcinol with aldehydes such as formaldehyde, acetic aldehyde or furfural are listed. It is also possible to use halogenated phenolic resin in which at least one halogen atom is combined with the aldehyde unit of the phenolic resin.

It is preferable to use alkylphenol•formaldehyde resin obtained by reaction of formaldehyde with alkylphenol having an alkyl group connected to the ortho position or the para position of benzene, because the alkylphenol•formaldehyde resin is compatible with rubber component and reactive, thus making a crosslinking reaction start time comparatively early. The alkyl group of the alkylphenol•formaldehyde resin has 1-10 carbon atoms. As the alkyl group, a methyl group, a propyl group, an ethyl group, and a butyl group are exemplified. Halides of alkylphenol•formaldehyde resin can be preferably used.

It is also possible to use denatured alkylphenol resin formed by addition condensation of para-tertiary-butylphenol sulfide and aldehydes and alkylphenol•sulfide resin as the resin crosslinking agent.

The mixing amount of the resin crosslinking agent is favorably 1 to 50 parts by mass for 100 parts by mass of the rubber component. This is because when the mixing amount of the resin crosslinking agent is less than one part by mass, the rubber component is insufficiently crosslinked. Thereby the thermoplastic elastomer composition has inferior properties such as the compression set. On the other hand, when the mixing amount of the resin crosslinking agent is more than 50 parts by mass, there is a case in which the hardness of the ink tube becomes too high. The mixing amount of the resin crosslinking agent is more favorably 8 to 15 parts by mass.

To appropriately make a dynamic crosslinking reaction, a crosslinking activator may be used. As the crosslinking activator, metal oxides are used. Zinc oxide and zinc carbonate are preferable.

The mixing amount of the crosslinking activator is so set that the property of the rubber component is sufficiently displayed. For example, the mixing amount of the crosslinking activator is favorably 0.5 to 10 parts by mass and more favorably 1 to 10 parts by mass for 100 parts by mass of the rubber component.

The organic peroxides are not limited to specific ones, but it is possible to use any compounds capable of crosslinking the rubber component. For example, benzoyl peroxide, 1,1-bis(tert-butylperoxy)-3,3,5-trimethylcyclohexane, 2,5-dimethyl-2,5-di(benzoylperoxy)hexane, di(tert-butylperoxy)diisopropylbenzene, 1,4-bis[(tert-butyl)peroxyisopropyl]benzene, di(tert-butylperoxy)benzoate, tert-butyl peroxybenzoate, dicumyl peroxide, tert-butyl cumyl peroxide, 2,5-dimethyl-2,5-di(tert-butylperoxy)hexane, di-tert-butyl peroxide, and 2,5-dimethyl-2,5-di(tert-butylperoxy)-3-hexene. These compounds may be used singly or in combination of two or more kinds thereof.

It is preferable that the mixing amount of the organic peroxide is 0.2 to 3.0 parts by mass for 100 parts by mass of the rubber component. This is because when the mixing amount of the organic peroxide is less than 0.2 parts by mass, the rubber component is insufficiently crosslinked and thus the thermoplastic elastomer composition has inferior properties such as the compression set and the like. On the other hand, when the mixing amount of the organic peroxide is more than 3.0 parts by mass, the property of the thermoplastic elastomer composition deteriorates owing to molecule cut and in addition defective dispersion occurs. Thereby it is difficult to process the thermoplastic elastomer composition.

The lower limit of the mixing amount of the organic peroxide is more favorably 0.5 parts by mass and especially favorably 1.0 part by mass for 100 parts by mass of the rubber component. The upper limit of the mixing amount of the organic peroxide is more favorably 2.5 parts by mass and especially favorably 2.0 parts by mass for 100 parts by mass of the rubber component.

A co-crosslinking agent may be used together with the organic peroxide. The co-crosslinking agent crosslinks itself and reacts with molecules of rubber and crosslinks them, thus making the entire rubber component polymeric. By co-crosslinking the rubber component with the co-crosslinking agent, it is possible to increase the molecular weight of crosslinked molecules and improve the wear resistance and the like of the thermoplastic elastomer composition.

As the co-crosslinking agent, polyfunctional monomers, metal salts of methacrylic acid or acrylic acid, methacrylate ester, aromatic vinyl compounds, heterocyclic vinyl compounds, allyl compounds, polyfunctional polymers to be obtained by utilizing the functional group of 1,2-polybutadiene, and dioximes are listed.

In using the co-crosslinking agent and the organic peroxide together, the mixing amount of the co-crosslinking agent can be selected appropriately according to the kind thereof and the kind of other components to be used. The mixing amount of the co-crosslinking agent is set to favorably not less than 5 nor more than 20 parts by mass and more favorably not less than 10 nor more than 15 parts by mass for 100 parts by mass of the rubber component.

The thermoplastic elastomer composition forming the ink tube of the present invention for the ink-jet printer may contain other components, unless the use thereof is contrary to the object of the present invention.

As other components, a softener can be used as necessary to provide the thermoplastic elastomer composition with a moderate degree of flexibility and elasticity.

As the softener, oil and a plasticizer can be used. As the oil, it is possible to use mineral oil such as paraffin oil, naphthenic oil, aromatic oil and known synthetic oil composed of a hydrocarbon oligomer, and process oil. As the synthetic oil, it is possible to use an oligomer of α-olefin, an oligomer of butene, and an amorphous oligomer of ethylene and α-olefin. As the plasticizer, phthalate-based, adipate-based, sebacate-based, phosphate-based, polyether-based, and polyester-based plasticizers are listed. More specifically dioctyl phthalate (DOP), dibutyl phthalate (DBP), dioctyl sebacate (DOS), and dioctyl adipate (DOA) are listed.

The mixing amount of the softener is set to favorably not more than 600 parts by mass and more favorably not more than 400 parts by mass for 100 parts by mass of the rubber component. When the mixing amount of the softener is more than the above-described range, the softener may bleed from the surface of the thermoplastic elastomer composition or may inhibit crosslinking and thus the rubber component is insufficiently crosslinked. Thereby the property of the thermoplastic elastomer composition may deteriorate. The lower limit of the mixing amount of the softener is not limited to a specific mixing amount, but should be so set as to obtain the effect to be obtained by the addition of the softener to the thermoplastic elastomer composition, namely, the effect of improving the dispersibility of the rubber component at a dynamic crosslinking time. Normally the mixing amount of the softener is set to not less than 15 parts by mass.

As the method of using the softener for the composition, a method of adding the softener to the composition before performing a dynamic crosslinking and thereafter kneading all the components and a method of adding the softener to a part of the components of the composition and kneading the softener and a part of the components and thereafter kneading all the components are exemplified.

As the latter method, a method of adding the oil-extended EPDM rubber to the composition and a method of using the oil-extended hydrogenated styrene thermoplastic elastomer are exemplified.

When the oil-extended EPDM rubber or the oil-extended hydrogenated styrene thermoplastic elastomer is used, the extended oil plays a role as the softener. Therefore the amount of the extended oil is regarded as the mixing amount of the softener.

To improve the mechanical strength of the thermoplastic elastomer composition, a filler can be added thereto.

As the filler, it is possible to list powder such as silica, carbon black, clay, talc, calcium carbonate, titanium oxide, dibasic phosphite (DLP), basic magnesium carbonate, and alumina.

It is preferable that the mixing amount of the filler is not more than 30 parts by mass for 100 parts by mass of the rubber component. When the ratio of the filler exceeds the above-described range, the flexibility of the thermoplastic elastomer composition deteriorates.

An acid-accepting agent can be used for the thermoplastic elastomer composition. When halogen-containing rubber such as chloroprene rubber, epichlorohydrin rubber or the halogenated isobutylene-isoprene copolymer rubber is used as the rubber component, by using the acid-accepting agent for the thermoplastic elastomer composition, it is possible to prevent a halogen gas generated at a dynamic crosslinking time from remaining.

As the acid-accepting agent, it is possible to use various substances acting as an acid acceptor. As the acid-accepting agent, carbonates of magnesium or calcium are exemplified as preferable examples. It is also possible to use hydrotalcites and magnesium oxide.

The mixing amount of the acid-accepting agent for 100 parts by mass of the rubber component is set to favorably not less than 0.1 nor more than 10 parts by mass and more favorably not less than 0.5 nor more than 5 parts by mass.

In addition, the thermoplastic elastomer composition may appropriately contain additives such as a lubricant, an age resistor, an antioxidant, an ultraviolet ray absorber, a pigment, an antistatic agent, a fire retarding agent, a neutralizing agent, a nucleating agent, an anti-foam agent, and the like.

As the lubricant, higher fatty amide, unsaturated fatty amide, and the like are exemplified.

As the age resistor, imidazoles such as 2-mercaptobenzimidazole; amines such as phenyl-α-naphthylamine, N,N′-di-6-naphthyl-p-phenylenediamine, and N-phenyl-N′-isopropyl-p-phenylenediamine; and phenols such as 2-6-di-tert-butyl-4-methylphenol, 2,2′-methylenebis(4-methyl-6-tert-butylphenol), and 2,5-di-tert-butylhydroquinone are listed.

The thermoplastic elastomer composition forming the ink tube of the present invention for the ink-jet printer can be produced by a method described below.

Initially the rubber component containing at least the butyl rubber, the olefin thermoplastic resin, the hydrogenated styrene thermoplastic elastomer, the crosslinking agent, and other desired additives are supplied to a kneader such as a Henschel mixer, a super-mixer or the like and kneaded or mixed with one another with a tumbler. All the components may be kneaded or mixed with one another all together or after a part of all the components may be kneaded or mixed with one another in advance, remaining components may be added to the components kneaded or mixed in advance and thereafter all the components may be kneaded or mixed with one another.

After the kneaded components or the mixed components are supplied to a uniaxial extruder or a twin screw extruder, with the kneaded components or the mixed components being heated to 150 to 250° C. and with a shearing force being applied thereto, the rubber component is dynamically crosslinked with the crosslinking agent. Thereafter the rubber component is dispersed in the mixture of the olefin thermoplastic resin and the hydrogenated styrene thermoplastic elastomer.

The dynamic crosslinking may be performed in the presence of halogen such as chlorine, bromine, fluorine or iodine. To allow the halogen to be present at a dynamic crosslinking time, it is favorable to use a halogenated rubber component described above or a halogen-donating substance. As the halogen-donating substance, tin chloride such as stannic chloride, ferric oxide, and cupric chloride are listed. In addition, halogenated resin such as chlorinated polyethylene may be used. One of the halogen-donating substances may be used singly or in combination of not less than two kinds thereof.

It is preferable to pelletize the thermoplastic elastomer composition obtained by carrying out the above-described method to facilitate processing to be performed at subsequent steps. Thereby it is possible to obtain a preferable moldability.

It is preferable to form the ink tube of the present invention for the ink-jet printer by carrying out a resin extrusion method so that the pelletized thermoplastic elastomer composition can be tubularly extruded. Thereby it is possible to obtain preferable extruded texture, excellent processability and moldability, and make the producing speed faster than the producing speed of vulcanized rubber and thereby improve the productivity to a higher extent. It is also possible to mold the thermoplastic elastomer composition by using an injection molding method or the like.

It is preferable that the air permeability of the ink tube obtained in the above-described manner is not more than 70 [g·mm/m²·day·atm(23° C.)] when the air permeability is measured in accordance with ASTM D 1434 Methods 5. Thereby it is possible to prevent the deterioration of ink caused by the permeation of oxygen or the like present at the peripheral side of the ink tube.

The vapor permeability of the ink tube is favorably not more than 0.60 and more favorably not more than 0.55. Thereby it is possible to prevent the evaporation of water contained in the ink capable of flowing to the inner peripheral side of the ink tube and prevent the solidification of the ink and prevent the tube from being clogged.

The vapor permeability is measured by the method described in the examples of the present invention.

It is preferable that the type A durometer hardness of the ink tube measured in accordance with JIS K6253 is not more than 60.

The reason the type A durometer hardness of the ink tube is set to not more than 60 is because when the type A durometer hardness of the ink tube connected to a moving portion such as an ink tank of a compact ink-jet printer is more than 60, the ink tube is incapable of obtaining a sufficient flexibility. Thus when the ink-jet printer is used, it is difficult for the ink to flow owing to kink (bending of tube) or the strength of a joint connected to the ink tube is adversely affected, when the ink-jet printer operates.

It is preferable that the compression set of the ink tube is not more than 30% when the compression set is measured in accordance with JIS K 6262 in a condition in which a measuring temperature is 70° C., a measuring period of time is 24 hours, and a compressibility is 25%.

This is because when the compression set exceeds 30%, a dimensional change of the ink tube is so large that the return performance thereof to its original state is liable to be unfavorable when the ink tube deforms. Further an end of the tube coupled to the joint is liable to slip off the joint.

The length, outer diameter, and thickness of the ink tube of the present invention for the ink-jet printer are not limited to specific dimensions, provided that the ink tube is tubular and formed by molding the thermoplastic elastomer composition. But from the standpoint of taking a balance between the vapor permeability of the ink tube as well as the air permeability thereof and the flexibility thereof, the thickness of the ink tube is set to preferably 0.5 mm to 3 mm.

### EFFECT OF THE INVENTION

The ink tube of the present invention for the ink-jet printer is formed by molding the thermoplastic elastomer composition in which as the rubber component, the butyl rubber and other rubber components are combined with each other, the content ratio of the butyl rubber is set to 30 to 80 mass % for the entire rubber component, and further as the matrix in which the dynamically crosslinked rubber component is dispersed, the mixture of the olefin thermoplastic resin and the hydrogenated styrene thermoplastic elastomer is used at a specific mixing ratio. Therefore the ink tube has excellent flexibility and processability and in addition has a small compression set. Therefore the ink tube has an excellent flexibility and returns to its original state when the ink tube deforms. Thereby the disposing form of the ink tube inside even a compact ink-jet printer is less restrictive, and the ink tube is capable of maintaining a preferable flow of ink. In addition because the ink tube of the present invention has a very low permeability of vapor and air, it is possible to restrain the water of the ink from evaporating and the ink from deteriorating.

Further because the thermoplastic elastomer composition can be molded by the resin extrusion molding, the thermoplastic elastomer composition has a good surface state and can be produced at a high productivity. Thus it is possible to produce the high-performance material for the ink tube at a low cost.

Therefore the ink tube coupled to the ink head and the like of the ink-jet printer can be preferably used to transport the ink, discharge waste ink to the outside of the ink head when the ink head is cleaned and supply the ink to the ink head from the ink tank.

### BRIEF DESCRIPTION OF THE DRAWINGS

FIG. 1 is a diagram of an ink tube of the present invention for an ink-jet printer.

### EXPLANATION OF REFERENCE SYMBOLS AND NUMERALS

10: ink tube
10a: inner peripheral surface
10b: peripheral surface

### BEST MODE FOR CARRYING OUT THE INVENTION

The embodiment of the present invention is described below with reference to the drawing.

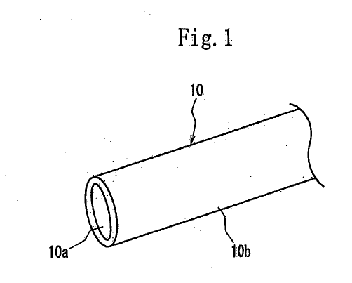

FIG. 1 shows an ink tube 10 of the present invention for an ink-jet printer.

The ink tube 10 coupled to an ink head and the like of the ink-jet printer is used to transport ink. When the ink head is cleaned, the ink tube 10 is used to discharge waste ink to the outside of the ink head and supply the ink to the ink head from an ink tank.

More specifically, the ink tube 10 is used with the ink flowing inside a hollow portion of the ink tube 10 and contacting an inner peripheral surface 10a of the ink tube 10 and with the open air contacting a peripheral surface 10b of the ink tube 10.

The ink tube 10 is formed by molding the thermoplastic elastomer composition. The thermoplastic elastomer composition contains the rubber component containing the butyl rubber at not less than 30 mass % nor more than 80 mass %, not less than 5 parts by mass nor more than 50 parts by mass of the olefin thermoplastic resin for 100 parts by mass of the rubber component, and not less than 10 parts by mass nor more than 100 parts by mass of the hydrogenated styrene thermoplastic elastomer for 100 parts by mass of the rubber component. The rubber component is finely dispersed in a matrix component consisting of a mixture of the olefin thermoplastic resin and the hydrogenated styrene thermoplastic elastomer by dynamic crosslinking.

The rubber component contains the butyl rubber and the EPDM rubber. As the butyl rubber, it is preferable to use isobutylene-isoprene copolymer rubber. Regarding the ratio of the butyl rubber and the EPDM rubber to the rubber component, the ratio of the butyl rubber to the entire rubber component is set to 30 to 80 mass % and preferably 50 to 70 mass %. The ratio of the EPDM rubber to the entire rubber component is set to 20 to 70 mass % and preferably 30 to 50 mass %.

As the olefin thermoplastic resin, polypropylene is used.

The mixing amount of the olefin thermoplastic resin is favorably 15 to 50 parts by mass and more favorably 20 to 40 parts by mass for 100 parts by mass of the rubber component. It is preferable to set the content of the olefin thermoplastic resin to 10 to 15 mass % in the entire composition.

As the hydrogenated styrene thermoplastic elastomer, it is preferable to use a styrene-ethylene-ethylene/propylene-styrene copolymer. The mixing amount of the hydrogenated styrene thermoplastic elastomer is favorably 10 to 100 parts by mass, more favorably 10 to 80 parts by mass, and especially favorably 15 to 60 parts by mass for 100 parts by mass of the rubber component.

Regarding the mixing ratio between the olefin thermoplastic resin and the hydrogenated styrene thermoplastic elastomer, it is preferable to use 50 to 200 parts by mass of the hydrogenated styrene thermoplastic elastomer for 100 parts by mass of the olefin thermoplastic resin.

As a crosslinking agent for crosslinking the rubber component, a resin crosslinking agent is preferable. It is especially preferable to use a phenolic resin crosslinking agent. The mixing amount of the phenolic resin crosslinking agent is 1 to 20 parts by mass and preferably 8 to 15 parts by mass for 100 parts by mass of the rubber component.

To properly make a crosslinking reaction, the crosslinking activator includes the zinc oxide. It is preferable to use 1 to 10 parts by mass of the zinc oxide for 100 parts by mass of the rubber component.

The softener includes paraffinic process oil. The mixing amount of the paraffinic process oil is 15 to 250 parts by mass, favorably 15 to 150 parts by mass, and more favorably 20 to 100 parts by mass for 100 parts by mass of the rubber component.

Although the thermoplastic elastomer composition forming the ink tube 10 of the present invention is produced by a method described below, the method of producing the thermoplastic elastomer composition is not limited to the method described below.

The above-described components are supplied to a tumbler at a required mixing ratio and mixed with one another. A mixing period of time is set to 15 minutes. A pellet of the thermoplastic elastomer composition is obtained by supplying the obtained mixture to a twin screw extruder, dynamically crosslinking it at 150 to 250° C., preferably 180 to 200° C., and dispersing the rubber component uniformly.

The pellet of the thermoplastic elastomer composition is tubularly extruded by carrying out a resin extruding method and using an extruder to form the ink tube 10 for the ink-jet printer shown in FIG. 1.

More specifically, after the pellet is tubularly extruded by using a single screw extruder at an extrusion temperature of 190 to 220° C., the extruded pellet is cut to a required length. In this manner, the ink tube 10 is produced.

The ink tube 10 may have any configurations, provided that the ink tube 10 is formed by molding the thermoplastic elastomer composition. But it is preferable to set the outer diameter and thickness of the ink tube to 2 mm to 10 mm and 0.5 mm to 3 mm respectively.

When the thickness of the ink tube 10 is less than 0.5 mm, the ink tube 10 is so thin that there is a fear that the ink tube 10 is incapable of keeping low vapor permeability and low air permeability. On the other hand, when the thickness of the ink tube exceeds 3 mm, the ink tube 10 lacks flexibility and it is difficult to bend the ink tube 10 inside a printer.

The air permeability of the ink tube 10 measured in accordance with ASTM D 1434 Methods 5 is not more than 70 [g·mm/m²·day·atm(23° C.)]. The vapor permeability of the ink tube 10 measured by the method described in the examples of the present invention is not more than 0.60. The type A durometer hardness of the ink tube 10 measured in accordance with JIS K6253 is not less than 40 nor more than 50. The compression set of the ink tube 10 measured in accordance with JIS K 6262 in a condition in which a measuring temperature is 70° C., a measuring period of time is 24 hours, and a compressibility is 25% is not less than 20% nor more than 30%.

The ink tube having properties in the above-described range is capable of sufficiently displaying various functions demanded as the ink tube. That is, the ink tube has a favorable flexibility, returns to its original state when it deforms, is excellent in its kink resistance, and is capable of preventing evaporation of the water of the ink flowing at the inner peripheral side of the ink tube and the deterioration of the ink.

Examples of the present invention and comparison examples are described in detail below.

Dynamically crosslinked thermoplastic elastomer composition of each of the examples and the comparison examples was formed by using the components shown in table 1. An ink tube, for an ink-jet printer, of each of the examples and the comparison examples was formed by using the obtained thermoplastic elastomer composition.

TABLE 1

| | | | | | Comparison | Comparison | Comparison | Comparison | Comparison | Comparison |
|---|---|---|---|---|---|---|---|---|---|---|
| | | Example 1 | Example 2 | Example 3 | example 1 | example 2 | example 3 | example 4 | example 5 | example 6 |
| Rubber | Butyl rubber | 70 | 70 | 50 | 20 | 90 | 70 | 70 | 70 | 70 |
| component | Other rubber | 30 | 30 | 50 | 80 | 10 | 30 | 30 | 30 | 30 |
| | components | | | | | | | | | |
| | Total | 100 | 100 | 100 | 100 | 100 | 100 | 100 | 100 | 100 |

| | | | | | | | | | |
|---|---|---|---|---|---|---|---|---|---|
| Olefin Thermoplastic resin | 30 | 30 | 30 | 30 | 30 | 10 | 60 | 30 | 30 |
| Hydrogenated styrene | 15 | 60 | 15 | 15 | 15 | 15 | 15 | 5 | 120 |
| thermoplastic elastomer | | | | | | | | | |
| Resin crosslinking agent | 12 | 12 | 12 | 12 | 12 | 12 | 12 | 12 | 12 |
| Softener | 50 | 50 | 50 | 50 | 50 | 50 | 50 | 50 | 50 |
| Zinc oxide | 5 | 5 | 5 | 5 | 5 | 5 | 5 | 5 | 5 |
| Processability in dynamic | ∘ | ∘ | ∘ | ∘ | ∘ | x | ∘ | ∘ | ∘ |
| crosslinking | | | | | | | | | |
| Hardness | 50 | 40 | 48 | 47 | 53 | — | 72 | 57 | 33 |
| Compression set | 28 | 27 | 27 | 28 | 27 | — | 46 | 26 | 36 |
| Vapor permeability | 0.46 | 0.45 | 0.55 | 0.72 | 0.41 | — | 0.45 | 0.44 | 0.42 |
| Air permeability | 53 | 52 | 70 | 88 | 46 | — | 50 | 52 | 57 |
| Processability test | Δ | ∘ | ∘ | ∘ | x | — | ∘ | x | Δ |

Materials used are as shown below.

Butyl rubber: isobutylene-isoprene copolymer rubber (“butyl 268” (commercial name) produced by Exxon Mobil Corporation)

Other rubber components: EPDM rubber (“Esprene 670F” (commercial name) produced by Sumitomo Chemical Co., Ltd.) (The EPDM rubber is oil-extended rubber and contains 50 mass % of process oil. Therefore 50 mass % of the mass of the added EPDM rubber is described in the column of “other rubber components” in table 1, whereas the remaining 50 mass % was treated as “softener”. That is, in the column of the “softener” in table 1, the sum of the amount of the paraffinic process oil shown below and the amount of the extended oil of the EPDM rubber is shown.)

Olefin thermoplastic resin: polypropylene resin (“BC6” (commercial name) produced by Nippon Polychemicals Co., Ltd.)

Hydrogenated styrene thermoplastic elastomer: a styrene-ethylene-ethylene/propylene-styrene copolymer (“SEPTON 4077” (commercial name) produced by Kuraray Co., Ltd.)

Resin crosslinking agent: halogenated alkylphenol resin crosslinking agent (“Tackirol 250-III (commercial name) produced by Taoka Chemical Co., Ltd.

Softener: paraffinic process oil (“Diana process oil PW-380” (commercial name) produced by Idemitsu Kosan Co., Ltd.

Zinc oxide: two kinds of zinc oxide (produced by Nippon Coke & Engineering Co., Ltd.)

The producing method is as described below.

After the components shown in table 1 were used at the ratio shown in table 1 and mixed with one another by using a tumbler, the components were kneaded with a twin screw extruder (“HTM38” produced by Aibeck Co., Ltd.) at a speed of 200 rpm, with the components being heated to 180 to 200° C., and the rubber component was to dynamically crosslinked. In this manner, the thermoplastic elastomer composition of each of the examples and the comparison examples was prepared and was pelletized.

Each of the obtained pellets was extruded at 190 to 220° C. and at a speed of 20 rpm by using a φ50 single screw extruder (produced by Kasamatsu Plastic Engineering & Research Co., Ltd.) to form the ink tube of each of the examples and the comparison examples.

The outer diameters of the obtained ink tubes of the examples were 4.0 mm±0.1 mm, and the thickness of each ink tube was 1.0 mm±0.1 mm. The outer diameters and thicknesses of the ink tubes were measured by using a projector.

Various evaluations were made on the ink tubes of the examples and the comparison examples by carrying out methods described below. Results of the evaluations are shown in table 1.

Processability in Dynamic Crosslinking

The configurations of the pellets were evaluated at two stages when the dynamic crosslinking was performed.

◯): Good. The rubber component of the pellet was dynamically crosslinked, and a uniform pellet was obtained.
X: Unacceptable. The thermoplastic elastomer composition was unfavorable in its flowability, and a powdery composition was obtained.

Hardness

In accordance with JIS K 6253, a type A durometer hardness test was conducted in a constant temperature and humidity condition where an ambient temperature was 23° C. and a relative humidity was 55%.

Compression Set

In accordance with JIS K6262, the compression set was measured at a measuring temperature of 70° C., for a measuring period of time of 24 hours, and at a compressibility of 25%.

Permeability of Vapor

After each of the ink tubes formed by molding the thermoplastic elastomer composition was cut to the length of 100 mm, pure water having a given mass was injected into the tube, and both ends thereof were sealed with clips. After the mass (initial mass) of each ink tube in which the water was enclosed was measured, the ink tube was left for seven days inside an oven having a temperature of 50° C. and a humidity of 55%, and the mass thereof was measured again to find the mass of decreased water, based on the difference between the re-measured mass of the water and the initial mass. The vapor permeability was computed from (decreased mass of water)/(mass of injected water).

Air Permeability

The air permeability of each ink tube was measured in accordance with the test method of ASTM D 1434 Methods 5 in the condition of 23° C. The unit is [g·mm/m²·day·atm].

Processability Test

In extruding each thermoplastic elastomer composition to form it into the ink tube, the degree of smoothness of the surface of each molding and the amount of resin generated at the mouthpiece of the extruder were evaluated visually at the following three stages.

◯: Excellent. The surface of the molding was smooth, and no resin was generated at the mouthpiece of the extruder.
Δ: Acceptable. Some unsmooth portions were observed on the surface of the molding or resin was generated to a very low extent at the mouthpiece of the extruder.
X: Unacceptable. Unsmooth portions were observed on the surface of the molding to a high extent or a large amount of resin was generated at the mouthpiece of the extruder.

From the test results of the examples and the comparison examples, it was found that in the thermoplastic elastomer composition of comparison example 1 containing a small amount of the butyl rubber had high vapor permeability and high air permeability. Thus the thermoplastic elastomer composition of comparison example 1 did not have preferable characteristics as the ink tube. The thermoplastic elastomer composition of comparison example 2 containing a large amount of the butyl rubber had low vapor permeability and low air permeability, but had low processability. Thus the thermoplastic elastomer composition was unpreferable.

It was difficult to dynamically crosslink the rubber component of the thermoplastic elastomer composition of comparison example 3 containing a small amount of the olefin thermoplastic resin, and a molding was not obtained. Thus evaluation could not be made thereafter. The thermoplastic elastomer composition of comparison example 4 containing a large amount of the olefin thermoplastic resin had a high hardness and a large compression set and was thus unpreferable.

The thermoplastic elastomer composition of comparison example 5 containing a small amount of the hydrogenated styrene thermoplastic elastomer had low processability and a comparatively high hardness and was thus unpreferable. The thermoplastic elastomer composition of comparison example 6 containing a large amount of the hydrogenated styrene thermoplastic elastomer had a comparatively large compression set and unpreferable processability and was thus unpreferable.

On the other hand, the thermoplastic elastomer compositions of examples 1 through 3 were excellent in the flowability thereof when the rubber component was dynamically crosslinked, could be easily molded, and in addition were excellent in the processability thereof. Further each of the thermoplastic elastomer compositions had excellent flexibility, low vapor permeability and low air permeability and a small compression set. Thus the thermoplastic elastomer compositions were excellent as the material for the ink tube.

1-5. (canceled)

6. An ink tube, for an inkjet printer, formed by molding a thermoplastic elastomer composition comprising:
a rubber component containing butyl rubber at not less than 50 parts by mass nor more than 70 parts by mass and ethylene-propylene-diene rubber at not less than 30 parts by mass nor more than 50 parts by mass;
not less than 15 parts by mass nor more than 60 parts by mass of a hydrogenated styrene thermoplastic elastomer for 100 parts by mass of said rubber component;
not less than 20 parts by mass nor more than 40 parts by mass of an olefin thermoplastic resin for 100 parts by mass of said rubber component, and
a resin crosslinking agent finely dispersing said rubber component by dynamic crosslinking.

7. An ink tube for an inkjet printer according to claim 6, wherein as said hydrogenated styrene thermoplastic elastomer, a styrene-ethylene-ethylene/propylene-styrene copolymer is used;
as said resin crosslinking agent, a phenol resin crosslinking agent is used and added to said rubber component at 8 to 15 parts by mass for 100 parts by mass of said rubber component;
zinc oxide is added to said rubber component at 0.5 to 10 parts by mass for 100 parts by mass of said rubber component;
as a softener, paraffinic oil is added to said rubber component at 20 to 100 parts by mass for 100 parts by mass of said rubber component

8. An ink tube for an inkjet printer according to claim 6 or 7, wherein air permeability measured in accordance with ASTM D 1434 Methods 5 is 52 to 70 [g·mm/m²·day·atm(23° C.)];
a type A durometer hardness measured in accordance with JIS K6253 is 40 to 50; and
a compression set measured in accordance with JIS K 6262 in a condition in which a measuring temperature is 70° C., a measuring period of time is 24 hours, and a compressibility is 25% is 20 to 30%.
